(19) United States
(12) Patent Application Publication
(10) Pub. No.: US 2013/0251961 A1
(43) Pub. Date: Sep. 26, 2013

(54) Interpenetrated Polymer Layer

(71) Applicants: Michael A. Johnson, Stillwater, MN (US); Thomas B. Galush, Roseville, MN (US); Gary A. Korba, Woodbury, MN (US); Jayshree Seth, Woodbury, MN (US); Kanta Kumar, Woodbury, MN (US)

(72) Inventors: Michael A. Johnson, Stillwater, MN (US); Thomas B. Galush, Roseville, MN (US); Gary A. Korba, Woodbury, MN (US); Jayshree Seth, Woodbury, MN (US); Kanta Kumar, Woodbury, MN (US)

(73) Assignee: 3M INNOVATIVE PROPERTIES COMPANY, St. Paul, MN (US)

(21) Appl. No.: 13/991,914

(22) PCT Filed: Dec. 12, 2011
(86) PCT No.: PCT/US2011/064318

§ 371 Date: Jun. 6, 2013

Related U.S. Application Data
(60) Provisional application No. 61/423,676, filed on Dec. 16, 2010.

(51) Int. Cl. C08J 7/04

(52) U.S. Cl. CPC C08J 7/04
USPC 428/195.1; 428/336; 428/213

(57) ABSTRACT

Structures having an interpenetrated polymer layer are described. The interpenetrating layer (230) comprises a mixture of a first component (211) and a second component (212), wherein the concentrations of the first component and the second component vary inversely across the thickness of the interpenetrating layer. Both interpenetrated surface layers (210, 220) and interpenetrated bonding layers (230) are described. Methods of forming an interpenetrated layer are also disclosed.

### FIELD

The present disclosure relates to structures having an interpenetrated polymer layer. Both interpenetrated surface layers and interpenetrated bonding layers are described. Methods of forming an interpenetrated layer are also disclosed.

### SUMMARY

Briefly, in one aspect, the present disclosure provides an article comprising a first layer comprising a first component and an interpenetrating layer integral with the first layer. The interpenetrating layer comprises a mixture of the first component and a second component, wherein the concentrations of the first component and the second component vary inversely across the thickness of the interpenetrating layer.

In some embodiments, the thickness of the interpenetrating layer is at least 5 nanometers. In some embodiments, the thickness of the interpenetrating network is no greater than 80% of the thickness of the first layer. In some embodiments, the thickness of the interpenetrating layer is between 10 and 200 nm, inclusive, e.g., between 10 and 50 nm, inclusive, e.g., between 20 and 50 nm, inclusive. In some embodiments, the thickness of the interpenetrating layer is between 30 and 150 nm, inclusive, e.g., between 50 and 150 nm, inclusive.

In some embodiments, the interpenetrating layer is a surface layer. In some embodiments, the first component is present throughout the thickness of the interpenetrating layer.

In some embodiments, the interpenetrating layer is bonding layer positioned between the first layer and a second layer comprising the second component. In some embodiments, the first component is not present in the second layer and the second component is not present in the first layer.

In some embodiments, the first component comprises a polyurethane. In some embodiments, the second component comprises a silicone. In some embodiments, the second component is fluorinated. In some embodiments, the second component comprises an acrylate. In some embodiments, the second component comprises silica nanoparticles.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary multilayer article according to the prior art.

FIG. 2 illustrates the composition profile at the bonding interface of the exemplary multilayer article according to the prior art of FIG. 1.

FIG. 3 illustrates an exemplary article according to some embodiments of the present disclosure.

FIG. 4 illustrates the composition profile across the interpenetrating bonding layer of the exemplary multilayer article of FIG. 3.

FIG. 5 is the elemental depth profile obtained for Example 1.

FIG. 6 is the elemental depth profile obtained for Example 2-1.

FIG. 7 is the elemental depth profile obtained for Example 2-3.

FIG. 8 is the elemental depth profile obtained for Example 2-6.

FIG. 9 is the elemental depth profile obtained for Example 4, after five liner reuses.

FIG. 10 is the elemental depth profile obtained for Example 4, after ten liner reuses.

FIG. 11 is the elemental depth profile obtained for Example 4, after fifteen liner reuses.

FIG. 12 is the elemental depth profile obtained for Example 7.

FIG. 13 is the elemental depth profile obtained for Example 16.

### DETAILED DESCRIPTION

Generally, multilayer articles are used in a wide variety of applications. For example, it is often difficult to find a single material that provides both the desired bulk properties such as mechanical strength, optical properties, and thickness, as well as the desired surface properties such as print receptivity, optical properties, environmental resistance, and the like. Typically, a first layer is used to provide the bulk properties, while a second layer, which is bonded to the first layer, is used to provide the desired surface properties.

In applications where the second layer is provided solely to impart desirable surface properties, there is often an advantage in providing as thin a layer as possible. However, many techniques for providing thin layers such as coating dilute solutions out of solvent, vacuum deposition, and sputter-coating are generally complex and add significant expense. In addition, these techniques result in a sharp, discrete interface between adjacent layer that can result in a weak boundary interface which can compromise the adhesion, integrity and overall performance of the layered construction.

Although a wide variety of methods are available for combining the first layer and the second layer, e.g., coating and laminating, undesirable separation of the first layer from the second layer remains a common problem. A wide variety of techniques have been employed to improve the bond between two layers including, e.g., the use of surface treatments, primers, adhesives, and the like. However, in addition to increasing the cost and complexity of producing such products, these approaches may still result in poor bonds, particularly between dissimilar materials, e.g., between high and low surface energy materials.

The present inventors have developed a method capable of applying uniform surface layers on polymeric substrates. Generally, the surface layer is strongly bonded to the substrate by an interpenetrating bonding layer comprising components of both the surface layer and the substrate. In some embodiments, the methods are solventless and do not require the use of vacuum. In some embodiments, continuous web-based processes may be used.

In some embodiments, nanoscale thick interpenetrating layers, e.g., between 10 and 200 nm, inclusive, can be obtained. In some embodiments, thinner layers may be useful, e.g., between 10 and 50 nm, inclusive, e.g., between 20 and 50 nm, inclusive. In some embodiments, the interpenetrating layer may be between 30 and 150 nm, inclusive, e.g., between 50 and 150 nm, inclusive.

An additional feature of these interpenetrating bonding layers is that the composition varies continuously as a function of thickness across the bonding layer. This feature can result in a layer having a composition with a continuously changing refractive index as a function of thickness, rather than the abrupt change in refractive index that can occur at discrete interfaces. In some embodiments, this feature has important ramifications in the area of optics.

As used herein, the term “interpenetrating polymer network” refers to thermoset interpenetrating polymer networks (often referred to in the literature simply as an interpenetrating polymer network), thermoplastic interpenetrating polymer networks, and pseudo interpenetrating polymer networks. Traditional, thermoset interpenetrating polymer networks comprise two thermoset polymers and may be formed by, e.g., coating a thermosetting polymerizable polymer precursor onto a thermoset film or coating. Similarly, thermoplastic interpenetrating polymer networks comprise two thermoplastic polymers and may be formed by, e.g., coating a thermoplastic polymerizable polymer precursor onto a thermoplastic film. Pseudo interpenetrating polymer networks typically comprise at least one thermoplastic polymer and at least one thermoset polymer. Such pseudo interpenetrating polymer networks may be formed by e.g., coating a thermoplastic polymerizable polymer precursor onto a thermoset film, or e.g., coating a thermosetting polymerizable polymer precursor onto a thermoplastic film.

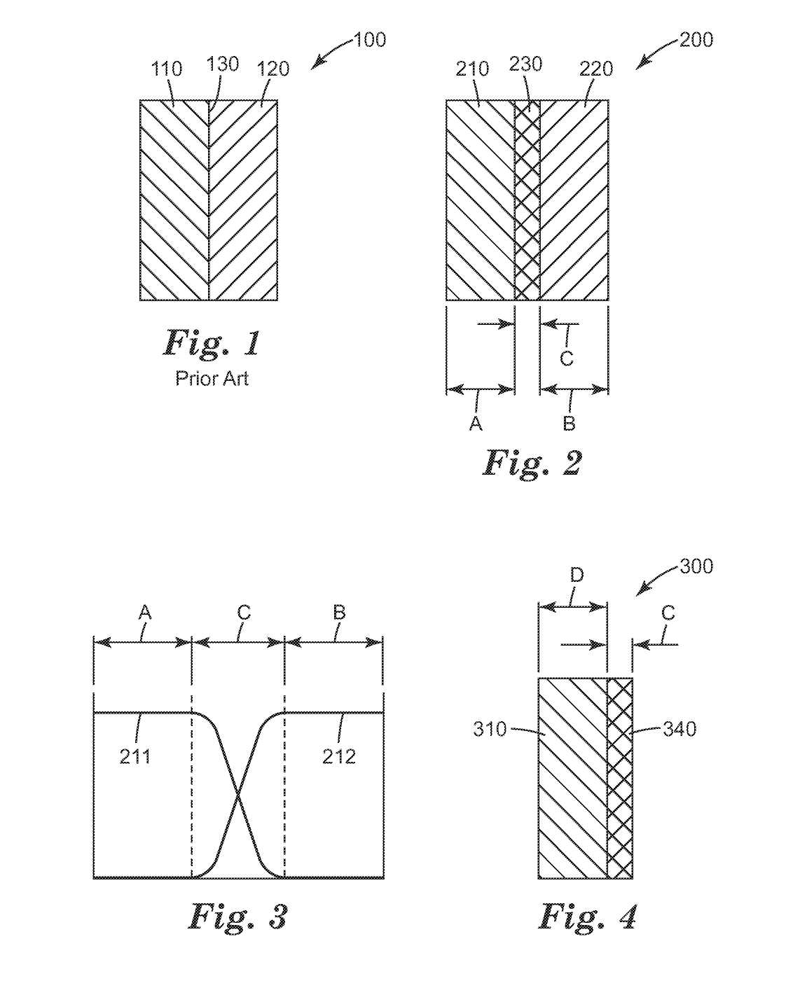

A typical multilayer article made by known methods is illustrated in FIG. 1. Multilayer article 100 consists of first layer 110 bonded to second layer 120. Generally, interface 130 between first layer 110 and second layer 120 is sharp, with an abrupt step-change in composition from the components comprising first layer 110 to the components comprising second layer 120.

A multilayer article according to some embodiments of the present disclosure is illustrated in FIG. 2. Multilayer article 200 comprises first layer 210 bonded to second layer 220. Interpenetrating bonding layer 230 is formed between first layer 210 and second layer 220. Interpenetrating bonding layer 230 comprises an interpenetrating network comprising at least first component 211 of first layer 210 and at least second component 221 of second layer 220.

In contrast to the sharp transition in composition at interface 130, the boundaries of interpenetrating bonding layer 230 less distinct. As illustrated in FIG. 3, the concentration of first component 211, shown by line 212 gradually decreases from the bulk of first layer 210, through interpenetrating bonding layer 230, toward second layer 220. Similarly, the concentration of second component 221, shown by line 222 gradually decreases from the bulk of second layer 220, through interpenetrating binding layer 230, toward first layer 210.

As shown in FIG. 3, the concentrations of the first and second component vary continuously and inversely across the bonding layer, resulting in no abrupt changes in composition or in properties that vary with composition such as refractive index. In contrast, abrupt changes in composition would arise at the single interface in structures like that shown in FIG. 1, or at multiple interfaces in systems using a separate bonding layer between two substrates.

In some embodiments, the interpenetrating layer may be a surface layer. As illustrated in FIG. 4, article 300 comprises first layer 310 and interpenetrating surface layer 340. Interpenetrating surface layer 340 comprises an interpenetrating network comprising at least first component 311 of first layer 310 and at least second component 321. Methods of forming such surface layers are described below. In some embodiments, as illustrated on FIG. 4, first component 311 of first layer 310 is present at exposed surface 305 of article 300. In some embodiments, there may be a skin layer free of first component 311 at exposed surface 305.

### EXAMPLES

TABLE 1
Summary of materials

| Liner | Description | Source |
|---|---|---|
| A | Proprietary UV-cured silicone on PET film | CP Films, Inc. |
| | (“UV10”) | |
| B | Proprietary silicone on PET liner (“4HLK”) | Mitsubishi |
| C | iodonium-catalyzed, UV-cured silicone on | 3M Company |
| | biaxially oriented polypropylene (BOPP) film | |
| D | iodonium-catalyzed, UV-cured fluorosilicone | 3M Company |
| | on polyester terephthalate (PET) film | |
| E | platinum-catalyzed, thermal-cured | 3M Company |
| | fluorosilicone on polycoated paper | |
| F | Tin-catalyzed, condensation-cured silicone | CP Films, Inc. |
| | (“T10”) | |
| G | Non-Fibrillated PTFE-containing coating on | described herein |
| | PET | |
| H | Fibrillated PTFE-containing coating on PET | described herein |
| I | Fibrillated PTFE-containing coating on PET | described herein |
| J | Acrylic hard coat, | described herein |
| K | Hydrophilic nanosilica-containing layer | described herein |

Polyurethane Preparation Procedure. A polyurethane precursor mixture was prepared by combining 6.0 grams of a multifunctional isocyanate (DEMODUR N3300A, Bayer Corp.) with 7.2 grams of a polyester diol (K-FLEX 188, King Industries) and mixing with a SPEEDMIXER (Flaktec, Inc. Landrum SC) for 15 seconds at 3450 rpm.

Dual-Liner Coating Procedure. The resulting mixture was coated between two substrates using a notched bar coating apparatus with the gap set to 125 microns. The mixture was allowed to cure under room temperature conditions for a minimum of 16 hours. The two substrates were then removed from the resulting cured polyurethane film.

Single-Liner Coating Procedure. The resulting mixture was coated on a substrate using a notched bar coating apparatus with the gap set to 125 microns. The mixture was allowed to cure under room temperature conditions for a minimum of 16 hours, with one surface of the mixture in contact with the substrate and the opposite surface exposed to the air. The substrate was then removed from the resulting cured polyurethane film.

XPS Procedure. The surface of the film was examined using using x-ray photoelectron spectroscopy (“XPS” also known as Electron Spectroscopy for Chemical Analysis “ESCA”). In XPS, a focused x-ray beam irradiates the sample producing photoelectrons which are then characterized as to their energy and intensity. The energies of the photoelectrons are specific to particular elements and their chemical states. XPS provides an analysis of the outermost 3 to 10 nanometers (“nm”) on the specimen surface. It is sensitive to all elements in the periodic table except hydrogen and helium with detection limits for most species in the 0.1 to 1 atomic % concentration range. All spectra were taken using a PHI VersaProbe 5000™ XPS system (Ulvac-PHI Inc., Chanhassen, Minn., USA), which uses a monochromatic aluminum K-alpha x-ray excitation source and a hemispherical electron energy analyzer operated in a constant pass energy mode. The base pressure in the instrument vacuum chamber during analysis was measured at approximately 2×10⁻⁶ Pascal (“Pa”) for all analyses.

Photoelectron emission spectra were recorded in a survey mode at each step in the depth profiles generated. These survey spectra were taken for 0 to 1200 electron volts (“eV”) in binding energy using a 117.4 eV Pass Energy and 0.50 eV per step per data point with 100 milliseconds (“ms”) dwell time per data point. All spectra were recorded using a 45° photoelectron collection (take-off) angle measured with respect to the sample surface with a ±20° solid angle of acceptance. The aluminum K-alpha x-ray source was operated at a power of 50 Watts which generated a 200 micrometer (“um”) diameter x-ray beam on each sample analyzed.

Elemental Depth Profiles were obtained on each sample by sequentially sputter etching the surface using an Ulvac-PHI Model #06-C60 C₆₀⁺ (“C60+”) ion gun and recording the appropriate XPS spectra. By repeating this process many times, a profile (concentration vs. sputtering time) was generated. Since the sputtering time is directly related to the thickness of the material removed, the profiles represent the elemental composition of the sample with respect to depth. All C60+ depth profiles were taken using a 10 thousand electron volt (“KeV”) Primary Beam Energy and a 10 nanoampere (“nA”) Beam Current with a Beam Raster Area of 3 millimeters (“mm”)×3 mm. The C60+ Ion Gun was mounted at an 18° Incidence Angle measured with respect to the sample surface. The C60+ etch rate was 10 nm/minute as measured on a 100 nm PMMA thin film deposited on a silicon wafer.

### Example 1 (EX-1).

The polyurethane precursor mixture was prepared according to the Polyurethane Preparation Procedure and coated between two samples of Liner-A according to the Dual-Liner Coating Procedure. The samples were aligned such that the silicone-coated surface of each liner sample was in contact with the mixture during curing.

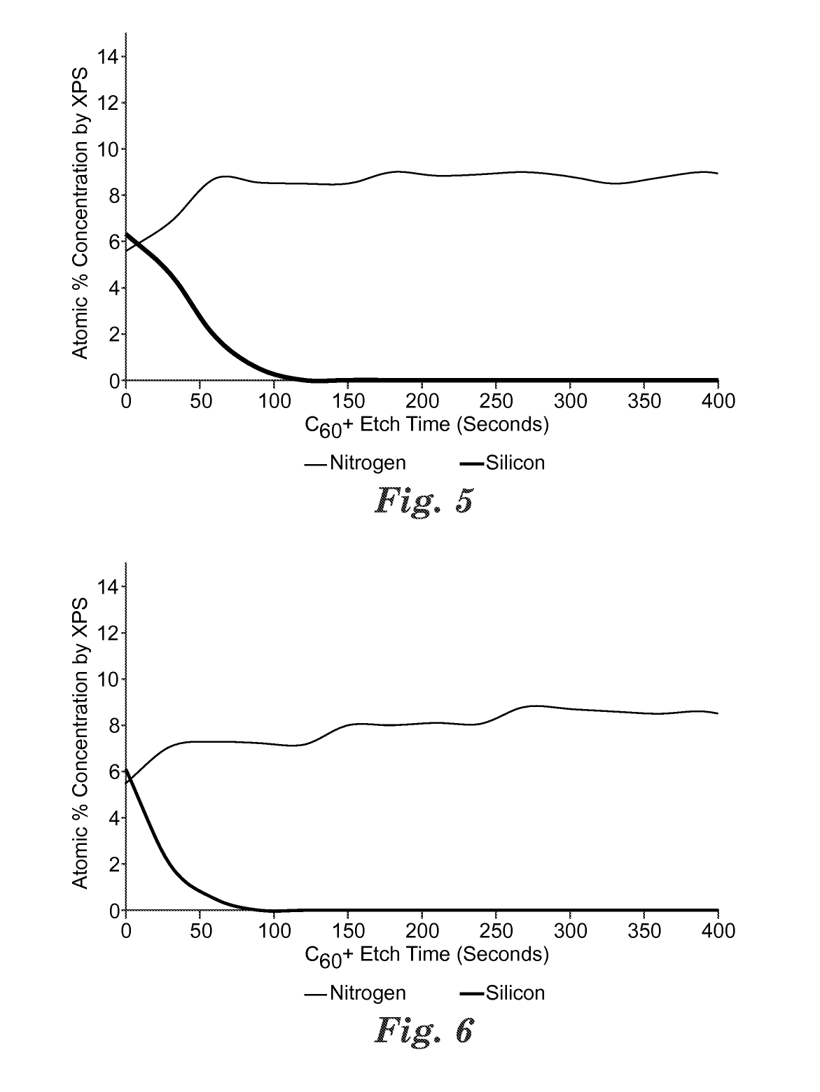

After removing the liners, an elemental depth profile was obtained according to the XPS Procedure. The atomic concentration of nitrogen (“N”) and silicon (“Si”) were plotted against sputtering time, as shown in FIG. 5. Nitrogen is a characteristic component of the urethane, while silicon is a characteristic component of the silicone release material. As shown in FIG. 5, an interpenetrated polymeric layer containing both polyurethane and silicone extends from the surface of Example 1 (i.e., etch time=0 seconds) to a depth of about 20 nm (etch time of 120 seconds). The surface concentration of nitrogen was 5.6 atomic percent.

### Examples 2-1 through 2-7.

Mixtures were prepared according to the Polyurethane Preparation Procedure except that the cure speed of the polyurethane was accelerated by adding increasing amounts of dibutyl tin dilaurate catalyst (DABCO T12, Air Products, Inc.). The samples are identified as EX 2-N, where N is equal to the number of drops of dibutyl tin dilaurate catalyst that were added. Each drop contained about 0.03 grams of the catalysts. Thus, e.g., EX 2-1 contained one drop (about 0.03 g) of the catalyst, while EX 2-7 contained 7 drops (about 0.21 g) of the catalyst.

Films made using the compositions of Examples EX 2-1 through EX 2-6 were coated between two samples of Liner-A according to the Dual-Liner Coating Procedure. XPS spectra were collected as a function of C60+ sputtering time. In each case, the nitrogen and silicon profiles indicate an interpenetrating surface layer extending from the surface of the film to a depth of about 15-20 nm. The atomic percent nitrogen on the surface of the interpenetrating layer, at a depths of 10 nm and 100 nm are summarized in Table 2. Depth profiles for Examples EX 2-1, -3, and -6 are shown in FIGS. 6, 7, and 8, respectively. Example EX 2-7 cured so quickly that it could not be coated, and no film could be produced.

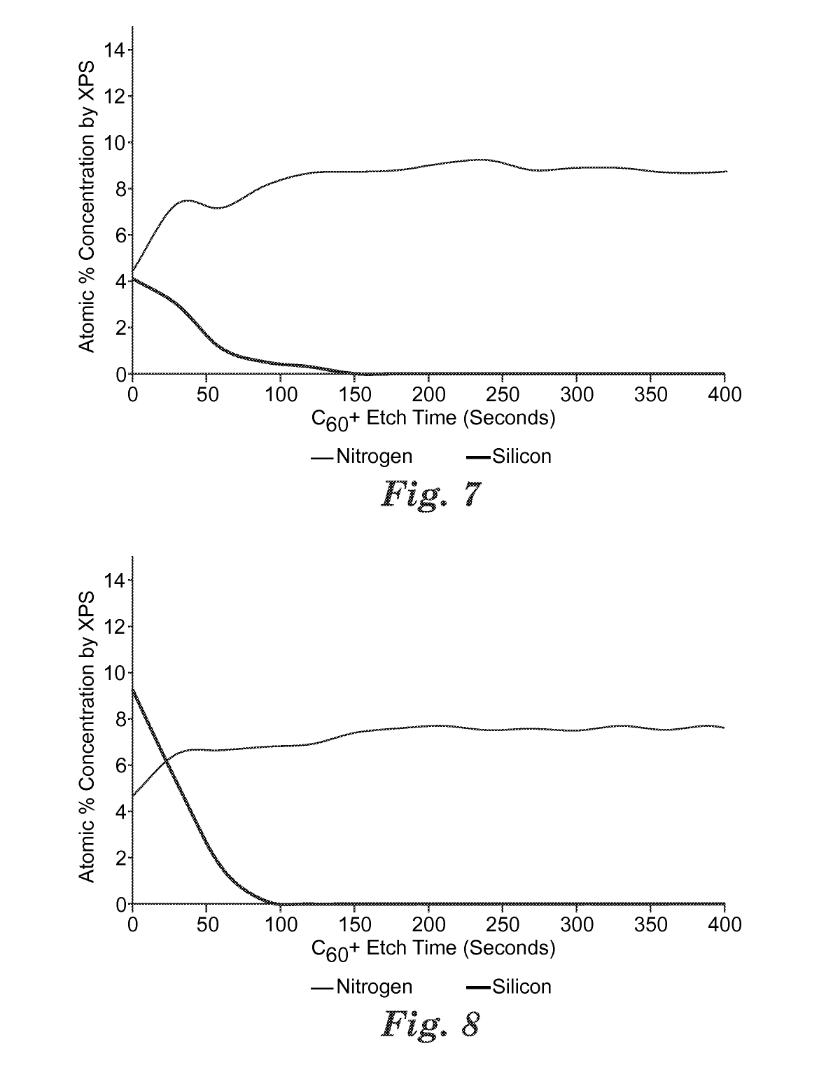

TABLE 2
Interpenetrating bonding layer thickness as a function of catalyst concentration.

| | Catalyst | | Silicon depth | | Atomic % N | | | Depth |
|---|---|---|---|---|---|---|---|---|
| Example | drops | grams | Etch time (s) | (nm) | Surface | 10 nm | 100 nm | Profile |
| EX-1 | 0 | 0 | 120 | 20 | 5.6 | 8.7 | 9.5 | FIG. 5 |
| EX 2-1 | 1 | 0.03 | 90 | 15 | 5.5 | 7.3 | 8.5 | FIG. 6 |
| EX 2-2 | 2 | 0.06 | 90 | 15 | 4.1 | 7.9 | 9.1 | — |
| EX 2-3 | 3 | 0.09 | 130 | 22 | 4.4 | 7.2 | 8.9 | FIG. 7 |
| EX 2-4 | 4 | 0.12 | 120 | 20 | 4.1 | 7.9 | 8.9 | — |
| EX 2-5 | 5 | 0.15 | 120 | 20 | 7.4 | 8.4 | 9.0 | — |
| EX 2-6 | 6 | 0.18 | 90 | 15 | 4.7 | 6.6 | 8.9 | FIG. 8 |

### Example 3

A polyurethane film was prepared and analyzed in the same manner as Example EX 2-1 (one drop of catalyst), except that the urethane was cast onto only one Liner-A substrate according to the Single-Liner Coating Procedure, with the other surface open to the air while curing. The XPS spectra as a function of sputtering time showed that no silicon was present on the air-exposed surface, while an interpenetrating bonding layer was formed near the surface cured in contact with the silicone release material. The interpenetrating layer contained silicon to a depth of about 10 to 20 nm (sputtering times of about 90 to 120 seconds) with a surface atomic nitrogen content of 5.1%.

### Example 4

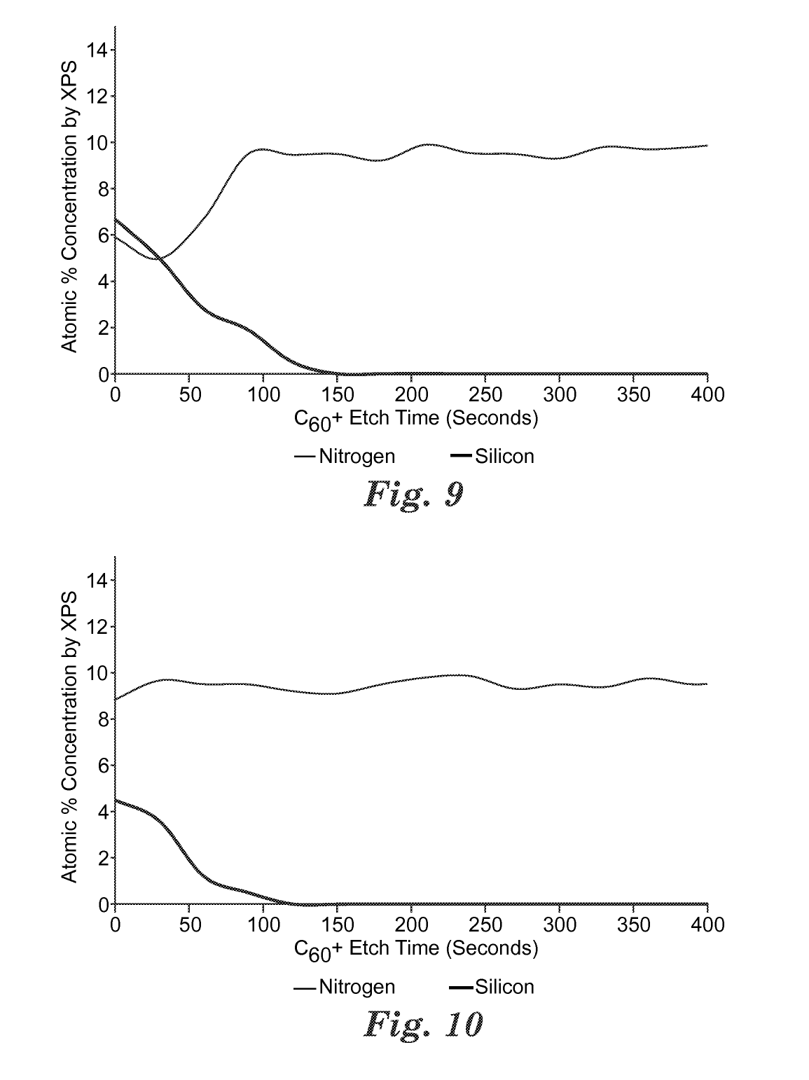

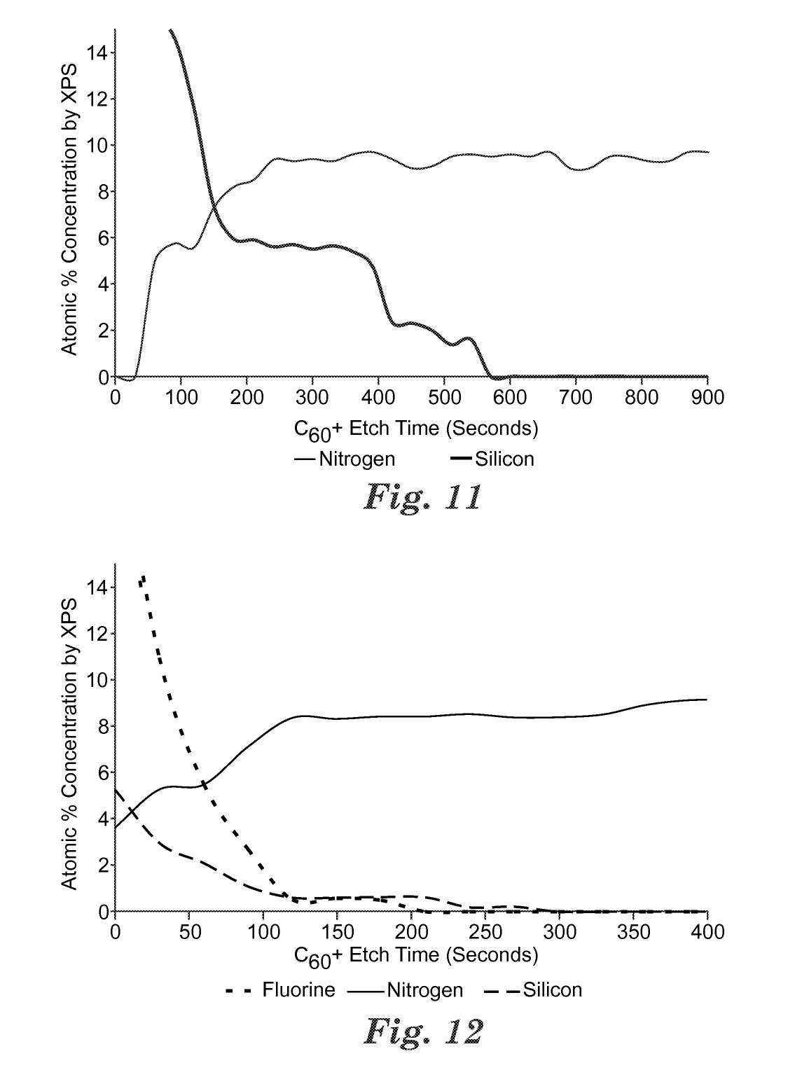

A series of polyurethane films were prepared according to procedures used for Example EX 2-1. A total of seventeen polyurethane films were prepared according to the Dual-Liner Coating Procedure. The same two Liner-A substrates that were used for the preparation of the first sample were reused for each subsequent sample. The surface composition and depth profile were measured for the polyurethane films after five (FIG. 9), ten (FIG. 10) and fifteen (FIG. 11).

Referring to FIGS. 9 and 10, the silicon concentration indicated an interpenetrating surface layer having a thickness of 15-20 nm and 5.9 atomic percent nitrogen at the surface after the fifth reuse. After the tenth reuse, an interpenetrating surface layer having a thickness of 10-15 nm with 8.8 atomic percent nitrogen at the surface was detected. By the fifteen reuse (see, FIG. 11), there was large scale silicone transfer to the surface of the polyurethane film as indicated by the spike in the silicon content and the absence of nitrogen at the surface. By the seventeenth reuse, so much silicone had been removed from the Liner-A substrates by the previous reuses that the urethane could not be peeled from the bare PET substrate of Liner-A.

### Examples 5 through 8, and Comparative Example CE-1.

A polyurethane film was prepared according to procedures used for Example EX 2-1 (one drop of catalyst), except that one of the Liner-A substrates was replaced by Liner-B, -C, -D, or -E, as summarized in Table 3. The liner was removed and the exposed surface of the cured polyurethane film was analyzed according to the XPS Procedure. As summarized in Table 3, an interpenetrating layer contained both urethane (as indicated by the nitrogen profile) and the release material (as indicated by the silicon profile for Ex. 5 and Ex-6; and the silicon and fluorine profiles for Ex. 7 and 8). The depth profiles of Ex. 7 for nitrogen, silicon, and fluorine are shown in FIG. 12

TABLE 3
Summary of Examples 5 through
8 and Comparative Example CE-1.

| | | | | | atomic % N | | |
|---|---|---|---|---|---|---|---|
| | | | Time | Depth | | 10 | 100 |
| Ex. | Liner | Release | (s) | (nm) | Surf. | nm | nm |
| 5 | B | proprietary, | 130- | 20-25 | 5.6 | 7.0 | 8.5 |
| | | commercially- | 150 | | | | |
| | | available | | | | | |
| | | silicone liner | | | | | |
| 6 | C | iodonium-catalyzed, | 130- | 25-30 | 5.6 | 6.4 | 8.2 |
| | | UV-cured silicone | 150 | | | | |
| 7 | D | iodonium-catalyzed, | 280- | 45-50 | 0.5 | 2.0 | 8.8 |
| | | UV-cured | 300 | | | | |
| | | fluorosilicone | | | | | |
| 8 | E | platinum-catalyzed, | 130- | 25-30 | 6.9 | 11.0 | 13.0 |
| | | thermal-cured | 150 | | | | |
| | | fluorosilicone | | | | | |

Four samples of CE-1 were prepared using Liner-F, a tin-catalyzed, condensation-cured silicone and XPS spectra were collected. Three samples showed no silicon in the outer 150 nm. One sample showed some silicon, but only to a depth of 2 to 5 nm. Tin is a known catalyst for urethane, while platinum and iodonium are not. The presence of tin in the silicone may have accelerated the cure of the urethane preventing the formation of an interpenetrating network, similar to the effect of adding to much tin catalyst in Ex. 2-7, described above.

### Example 9

A polyurethane film was prepared according to procedures used for Example EX 2-1 (one drop of catalyst), except that one of the Liner-A substrates was replaced by a 50 micron thick biaxially oriented polypropylene (BOPP) film in the Dual-Liner Coating Procedure. The BOPP film was removed and the exposed surface of the cured polyurethane film was analyzed according to the XPS Procedure. A 50 to 60 nm thick (250 to 300 seconds of etch time) interpenetrating surface layer was formed. The interpenetrating layer contained both urethane (as indicated by the nitrogen profile) and a hydrocarbon (as indicated by the carbon profile).

### Comparative Example 2

A polyurethane film was prepared according to procedures used for Example EX 2-1 (one drop of catalyst), except that one of the Liner-A substrates was replaced by a 50 micron thick high density polyethylene (HDPE) film in the Dual-Liner Coating Procedure. The HDPE film was removed and the exposed surface of the cured polyurethane film was analyzed according to the XPS Procedure. There was no evidence of an interpenetrating surface layer. Unlike the amorphous silicone and BOPP materials, HDPE is crystalline.

### Example 10

Several drops of a non-curing silicone fluid (BYK-331) were applied to the surface of a polycarbonate film. The surface was wiped to provide a uniform thin layer of the silicone fluid. A polyurethane film was then prepared according to procedures used for Example EX 2-1 (one drop of catalyst), except that one of the Liner-A substrates was replaced by the silicone fluid-coated polycarbonate film in the Dual-Liner Coating Procedure. The polycarbonate film was removed and the exposed surface of the cured polyurethane film was analyzed according to the XPS Procedure. A 20 to 30 nm thick (80 to 110 second etch time) interpenetrating surface layer comprising both urethane and silicone was detected.

### Examples 11 through 13

A polymer of tetrafluoroethylene, hexafluoropropylene and vinylidene (32 wt. % solid fluoropolymer latex available as THV200 from Dyneon LLC, Oakdale,

Minnesota) (900 g) was blended with 352.9 g of a tetrafluoroethylene homopolymer (20.4 wt. % solid aqueous dispersion available as PTFE 5032 from Dyneon LLC). The blend ratio was 80:20 wt. % based on solid content. The latex blend (1252.9 g) was coagulated with MgCl2.6H2O solution (60 g MgCl2 in 2500 g D.I. water) and washed with hot water (70° C.) and dried under at 130° C. for 16 hours.

Subsequently, the dried fluoropolymer blend (10 g) was dissolved in MEK solvent (190 g) at 5 wt. % by shaking at room temperature. The prepared fluoropolymer dispersion-solution was combined with 3-(2 aminoethyl) aminopropyltrimethoxysilane in 5 wt. % methanol. The ratio of fluoropolymer blend content to the aminosilane by wt. % was 95:5.

The resulting coating solution was coated onto regular PET film with a #3 Meyer bar. The material was dried in a conventional air flotation oven and, subsequently, the resulting coatings were placed in an oven at 120° C. for 10 minutes. The result was a nonfibrillated fluoropolymer coated PET film identified as Liner G.

The fluoropolymer coating of Liner G was buffed with a paper towel. This resulted in a fibrillated fluoropolymer sample identified as Liner H. This process was repeated using a lower fluoropolymer coat weight. The resulting fibrillated fluoropolymer sample is identified as Liner I.

A polyurethane film was prepared according to procedures used for Example EX 2-1 (one drop of catalyst), except that one of the Liner-A substrates was replaced by a substrate comprising polytetrafluoroethylene (PTFE) as summarized in Table 4. The PTFE-containing substrate was removed and the surface of the cured polyurethane film was analyzed according to the XPS Procedure. A surface layer comprising both urethane (as indicated by the nitrogen concentration) and PTFE (as indicated by the fluorine concentration) was detected in each case, as summarized in Table 4.

TABLE 4
Summary of Examples 11 through 13.

| | | | Time | Depth | Atomic % Nitrogen | | |
|---|---|---|---|---|---|---|---|
| Ex. | Liner | Fluoropolymer | (s) | (nm) | Surf. | 10 nm | 100 nm |
| 11 | G | non-fibrillated | 80-100 | 15-20 | 7.4 | 7.5 | 9.0 |
| 12 | H | fibrillated | 400-425 | 65-70 | 3.6 | 6.8 | 9.0 |
| 13 | I | fibrillated | 300-325 | 45-50 | 7.1 | 7.4 | 9.2 |

### Example 14

Preparation of Liner J. An acrylic hard coat was prepared by charging isostearyl acrylate (NK ESTER ISA from Osaka Organic Chemical Industry Ltd.), stearyl acrylate (NK ESTER STA) and EBECRYL P36 photoinitiator (acrylated benzophenone derivative, Daice-UCB Co., Ltd) in monomer ratio of 50/50/0.4 in a blend of 50:50 ethyl acetate/heptanes having a solids content of 60% by weight. Then 0.3 parts of initiator V-601 (2,2′-azobis(2-methylpropionate)) was charged followed by purging the contents in the container with nitrogen gas for 10 minutes. The container was sealed and placed in a rotary constant-temperature bath maintained at 50° C. The reaction continued for 24 hours.

A polyurethane film was prepared according to procedures used for Example EX 2-1 (one drop catalyst), except that one of the Liner-A substrates was replaced by an PET film coated with an acrylic polymer hard coat (Liner J) in the Dual-Liner Coating Procedure. Liner J was removed and the exposed surface of the cured polyurethane film was analyzed according to the XPS Procedure. A 30 to 35 nm thick interpenetrating surface layer comprising both urethane (as indicated by the nitrogen concentration) and acrylate (as indicated by the oxygen concentration) was detected.

### Example 15

Preparation of Liner K. In a round-bottomed flask were mixed 1195 grams NALCO 2327 silica sol, commercially available from Nalco Chemical Co. (an ammonium ion-stabilized dispersion having a pH of 9.3 of colloidal silica particles, 40 percent solids, with an average particle diameter of 20 nanometers); 118 grams N,N-dimethyl acrylamide, commercially available from Aldrich Chemical Co; 120 grams 3-(trimethoxysilyl)propyl methacrylate coupling agent, commercially available from Aldrich Chemical Co.; and 761 grams pentaerythritol triacrylate (SR444—SARTOMER COMPANY, WEST CHESTER, Pa.). The round-bottomed flask was subsequently mounted on the vacuum line of a BUCHI R152 Rotavapor, commercially available from Buchi Laboratory AG, Flanil, Switzerland with the bath temperature set to 55° C. A refrigerated mixture of 50 percent deionized water/50 percent antifreeze, was recirculated through the cooling coils. Volatile components were removed at a reduced pressure of 25 Torr until the distillation rate was reduced to less than 5 drops per minute (approximately 2 hours.) The resulting material (1464 grams) was a clear liquid dispersion of acrylated silica particles in a mixture of N,N-dimethyl acrylamide and pentaerythritol triacrylate monomers (a ceramer composition). To this mixture was added 1282 grams of isopropanol, 87 grams of water, 29 grams of TINUVIN 292 hindered amine, and 36 grams of IRGACURE 184 photoinitiator. The final composition contained about 50% solids and is amber to hazy in appearance.

The resulting composition was coated onto Liner J using a #3 wire wound bar (R.D.S. Webster N.Y.). The coated film was cured using a high-pressure mercury lamp (H type) manufactured by Fusion System Corporation with ultraviolet (UV) radiation energy density of 164 mJ/cm2 to give a cured hardcoat on release liner film identified as Liner-K.

A polyurethane film was prepared according to procedures used for Example EX 2-1 (one drop catalyst), except that one of the Liner-A substrates was replaced by Liner K in the Dual-Liner Coating Procedure. Liner K was removed leaving the nanosilica-containing acrylic polymer bonded to the cured polyurethane film. The resulting article showed three distinct regions.

The outer-most layer was the acrylic hardcoat with silica nanoparticles, indicating bulk transfer of at least a portion of the hardcoat to the urethane film. A pure polyurethane support layer was also present. Between these layers, an interpenetrating bonding layer, which contained both the urethane and the silica-containing hardcoat, was detected.

The sample was analyzed according to the XPS procedure except that the outer-most layer was etched with Ar+, which the interpenetrating layer and the urethane layer were etched with C60+. A 150 nm thick (10,000 to 11,000 second etch time) interpenetrating bonding layer comprising urethane (as indicated by the nitrogen concentration), acrylate (as indicated by the oxygen concentration), and silica (as indicated by the silicon concentration) was detected. The interpenetrating bonding layer was located between the polyurethane and a surface layer of the nanosilica-containing acrylate polymer. The surface layer contained no detectable nitrogen, indicating that urethane was not present at the outermost surface of the nanosilica-containing acrylic polymer layer.

### Example 16

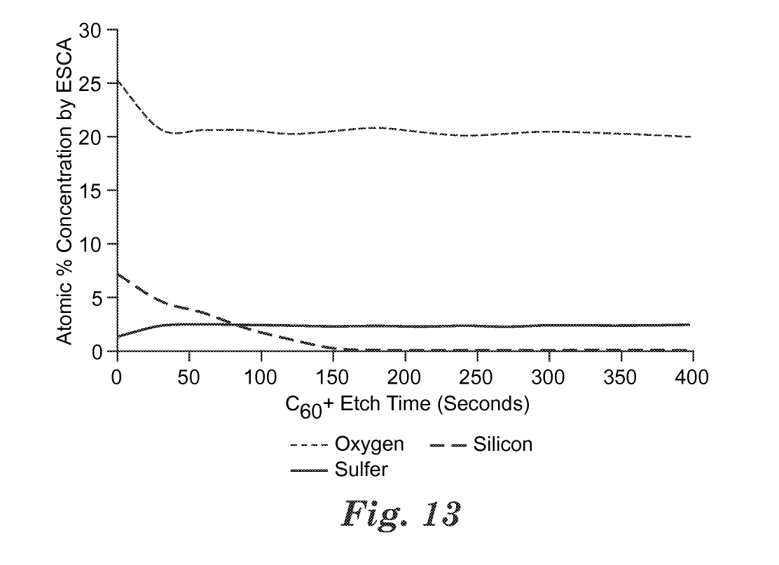

A two-part, mercaptan-cured epoxy adhesive (DP100 available from 3M Company) was used in place of the polyurethane precursor mixture to prepare a sample according the Dual-Liner Coating Procedure. The substrates were both Liner-A. The epoxy was allowed to cure overnight and then Liner-A was removed and the exposed surface of the epoxy film was analyzed. As illustrated in FIG. 13, a 23 to 30 nm thick interpenetrating surface layer comprising both urethane (as indicated by the nitrogen concentration) and epoxy (as indicated by the sulfur concentration from the mercaptan curative) was detected.

### Example 17

### Microstructured Interpenetrating Polymer Layers.

A microstructured liner was prepared using a polycoated kraft paper coated with low density polyethylene on one side and high density polyethylene on the other. This substrate was coated with a tin-free silicone release material. The sample was embossed to provide a pattern of pyramidal structures with a depth of 25 microns and pitch of 192 microns in accordance with WO 2009/131792 A1.

A polyurethane precursor mixture was prepared by combining 13.4 grams of a multifunctional isocyanate (DEMODUR N3300A), 15.0 grams of a polyester diol (K-FLEX 188), 1.25 grams of a pigment dispersion (10 wt. % carbon black dispersed in K-FLEX 188 polyester diol), and 0.035 g dibutyl tin dilaurate catalyst (DABCO T12). Cured polyurethane films were prepared according to the Dual-Liner Coating Procedure using the microstructured, silicone-coated release liner as one of the substrates. The resulting cured polyurethane film had a microstructured surface corresponding to the microstructure features of the liner. The microstructured surface of the urethane film was analyzed using the XPS Procedure to identify the presence of an interpenetrating surface layer. DATA

### Comparative Example 3

The preceding examples were prepared by casting polyurethane precursors on a variety of substrates and curing the urethane while in contact with the substrate. As illustrated above, interpenetrating bonding layers were formed. For comparison, a thermoplastic, polyester-based, polyurethane polymer (A65 from Huntsman) was evaluated. The polymeric polyurethane was melted in a vacuum oven at 240° C. and applied between two tin-free-silicone coated release liners (CERAPEEL WD/WHF from Mitsui Plastics) using a notch bar coater. A hot plate was placed beneath the bed of the coater and turned to the highest setting in order to heat the bed prior to casting of the film. The resulting sample was analyzed using the XPS Procedure. A surface silicone layer of only 6-8 nm in thickness was detected. This layer contained less than 1.7 atomic percent nitrogen. Both the thickness of less than 10 nm and the low atomic percent nitrogen indicate the lack of a nanoscale interpenetrating layer.

Various articles of the present disclosure may be used in a wide variety of applications. The presence of the interpenetrating polymer network interface can be applied to a number of areas including interfacial adhesion improvement and/or control, anti-fingerprint, and surface energy modification for specific property optimization. The use of the thin layers generated by various processes of the present disclosure allow surface properties to be tailored without the financial and material property disadvantages associated with applying thicker surface layers. The presence of the interpenetrating polymer network interface can also be used to achieve desired optical properties suitable for lenses, micro-lenses, antiglare applications, flexible cladding low index skins for light guide cores, higher transmission optical laminates, gradient indexed lens, and the like. Other potential applications include, e.g., solar cells, optical displays, and ophthalmic applications.

Various modifications and alterations of this invention will become apparent to those skilled in the art without departing from the scope and spirit of this invention.

1. An article comprising a first layer comprising a first component and an interpenetrating layer integral with the first layer, wherein the interpenetrating layer comprises a mixture of the first component and a second component, wherein the concentrations of the first component and the second component vary inversely and continuously across the thickness of the interpenetrating layer, wherein the thickness of the interpenetrating layer is at least 10 nanometers.

2. (canceled)

3. The article of claim 2, wherein the thickness of the interpenetrating network is no greater than 80% of the thickness of the first layer.

4. The article of claim 3, wherein the thickness of the interpenetrating layer is between 10 and 200 nm, inclusive.

5. The article of claim 4, wherein the thickness of the interpenetrating layer is between 10 and 50 nm, inclusive.

6. The article of claim 4, wherein the thickness of the interpenetrating layer is between 50 and 150 nm, inclusive.

7. The article according to claim 1, wherein interpenetrating layer is a surface layer comprising the first component and the second component throughout the thickness of the interpenetrating layer.

8. The article according to claim 1, wherein interpenetrating layer is bonding layer positioned between the first layer and a second layer comprising the second component.

9. The article according to claim 8 where in the second layer is a continuous layer.

10. The article according to claim 8 where in the second layer is a discontinuous layer.

11. The article according to claim 8, wherein the first component is not present in the second layer and the second component is not present in the first layer.

12. The article according to claim 1 any one of the preceding claims, wherein the first component comprises a polyurethane.

13. The article according to claim 1 any one of the preceding claims, wherein the second component comprises a silicone.

14. The article according to claim 1 any one of the preceding claims, wherein the second component is fluorinated.

15. The article according to claim 1 any one of the preceding claims, wherein the second component comprises an acrylate.

16. The article according to claim 1 any one of the preceding claims, wherein the second component comprises silica nanoparticles.

17. The article according to claim 1 any one of the preceding claims, wherein the interpenetrating layer is microstructured.
